(19) United States
(12) Patent Application Publication
(10) Pub. No.: US 2018/0003058 A1
(43) Pub. Date: Jan. 4, 2018

(54) VENTILATION DUCT

(71) Applicant: Hiram (WA) Pty Ltd., Forrestfield (AU)

(72) Inventor: Steven Peter DURKIN, Forrestfield (AU)

(21) Appl. No.: 15/637,534

(22) Filed: Jun. 29, 2017

(30) Foreign Application Priority Data
Jun. 30, 2016 (AU) 2016902578

(51) Int. Cl. E21F 1/04; C09K 21/00; B32B 27/28; C08K 3/08; F16L 9/14; F16L 9/12

(52) U.S. Cl. CPC E21F 1/04; F16L 9/14; F16L 9/121; B32B 27/285; C08K 3/08; C09K 21/00

(57) ABSTRACT

A ventilation duct 10, the duct 10 comprising a substantially rigid, elongate tube section 12 moulded from plastics material and having a tube wall 14 comprising a plurality of layers. At least one of the layers comprises an intumescent material which acts as a fire retardant in the event of exposure to extreme heat.

### FIELD OF THE INVENTION

The present invention relates to a ventilation duct and relates particularly, though not exclusively, to a ventilation duct for underground mineshafts and tunnels.

### BACKGROUND TO THE INVENTION

Underground mineshafts and tunnels need to be well ventilated to provide clean breathable air from the surface for underground mine workers and to remove potentially harmful or dangerous gases from underground. Primary ventilation systems typically employ large fans located at the surface, and secondary ventilation typically comprises fans and ducts inside the mine.

Ventilation ducts used in mines take a variety of forms, including: flexible, welded tubing made of plastics material; duct pipe of moulded plastics material; spiral-reinforced ducting of extruded plastics material with spring steel wire welded to the ducting (used with positive and negative pressures); rigid shaft tubing of plastics material; and, metal ducting made of galvanised steel (round or oval). Typical plastics materials used in ventilation ducts are polyethylene, polyethylene woven coated fabric or polyester coated PVC.

One of the problems with ventilation ducts made of plastics material is the need to hand weld the sheet of plastics material into a tube. Another problem with ventilation ducts made of plastics material is the potential for combustion in the event of exposure to extreme heat. For this reason many countries require the materials employed in ventilation ducting in underground mines to be fire resistant. Polyethylene is a highly combustible polymer. The most common methods for making polyethylene fire retardant are addition, incorporation or coating with flame-retardant compounds. One form of prior art ventilation ducting is made from flexible polyethylene woven fabric which is impregnated with a fire retardant chemical.

One of the disadvantages of prior art approaches to making polyethylene fire retardant is that the addition or incorporation of the fire retardant chemical in the polymer matrix makes it more difficult to mould, especially when using rotational moulding. Another disadvantage is that the fire retardant chemicals employed, such as phosphorus-containing compounds, bromine-containing compounds and bromine-containing compounds together with antimony trioxide, are often hazardous to use during the manufacturing process.

The present invention was developed with a view to providing a ventilation duct which is less susceptible to the disadvantages of the prior art and that incorporates an intumescent material which acts as a fire retardant in the event of extreme heat exposure.

References to prior art in this specification are provided for illustrative purposes only and are not to be taken as an admission that such prior art is part of the common general knowledge in Australia or elsewhere.

### SUMMARY OF THE INVENTION

According to one aspect of the present invention there is provided a ventilation duct, the duct comprising:

a substantially rigid, elongate tube section moulded from plastics material and having a tube wall comprising a plurality of layers, at least one of the layers comprising an intumescent material which acts as a fire retardant in the event of exposure to extreme heat.

In one embodiment the tube section has a tube wall comprising an inner layer of a first plastics material and an outer layer of a second plastics material, the second plastics material of the outer layer comprising an intumescent material.

In another embodiment the tube section has an intermediate layer of a first plastics material, an inner layer of a second plastics material, and an outer layer of the second plastics material, the second plastics material of both the inner layer and the outer layer comprising an intumescent material.

Advantageously the second plastics material is a metallocene polyethylene-based compound. Typically the intumescent material is an intumescent resin provided in a powder form suitable for rotational moulding. Preferably the intumescent resin is a product called DPO P509 developed by Total Petrochemicals & Refining SA/NV. DPO P509 typically has a density of 1.07 g/cm³, a melt flow rate of 12.0 g/10 min, and a melting point of 119° C.

Preferably the first plastics material is a high density polyethylene (HDPE) material.

Preferably the tube section is moulded using a rotational moulding process.

Advantageously the tube wall is formed with a bevelled annular edge region at a first end of the tube section, and a flared annular edge region at a second end of the tube section wherein, in use, the bevelled annular edge region is adapted to be received in a flared annular edge region of a substantially identical adjacent tube section, which is joined end to end with the tube section.

Preferably each tube section is provided with a plurality of stiffening straps at spaced intervals along its length, each strap extending around the circumference of the tube section.

According to another aspect of the present invention there is provided a method of manufacturing a ventilation duct, the method comprising the steps of:

moulding a first layer of plastics material;
moulding a second layer of plastics material bonded to the first layer, at least one of the first and second layers including an intumescent material; and,
curing the plastics material so as to form a substantially rigid tube section having a multi-layer tube wall, and wherein the intumescent material acts as a fire retardant in the event of exposure to extreme heat.

In one embodiment the method further comprises the step of:

moulding a third layer of plastics material bonded to the second layer.

Preferably the moulding steps are performed as part of a rotational moulding process.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of a ventilation duct, given by way of example only, with reference to the accompanying drawings, in which:

FIG. 1 is a side elevation of a tube section of a first embodiment of the ventilation duct according to the present invention;

FIG. 2 is a section view through the line A-A of the tube section of FIG. 1;

FIG. 3 is an enlarged view of detail B in FIG. 2;

FIG. 4 is a top perspective view of the tube section of FIG. 1;

FIG. 5 is a semi-transparent top perspective view of the tube section of FIG. 1, viewed from one end;

FIG. 6 is a side elevation of a tube section of a second embodiment of the ventilation duct according to the present invention;

FIG. 7 is a section view through the line C-C of the tube section of FIG. 6; and

FIG. 8 is an enlarged view of detail D in FIG. 7.

### DETAILED DESCRIPTION OF PREFERRED EMBODIMENTS

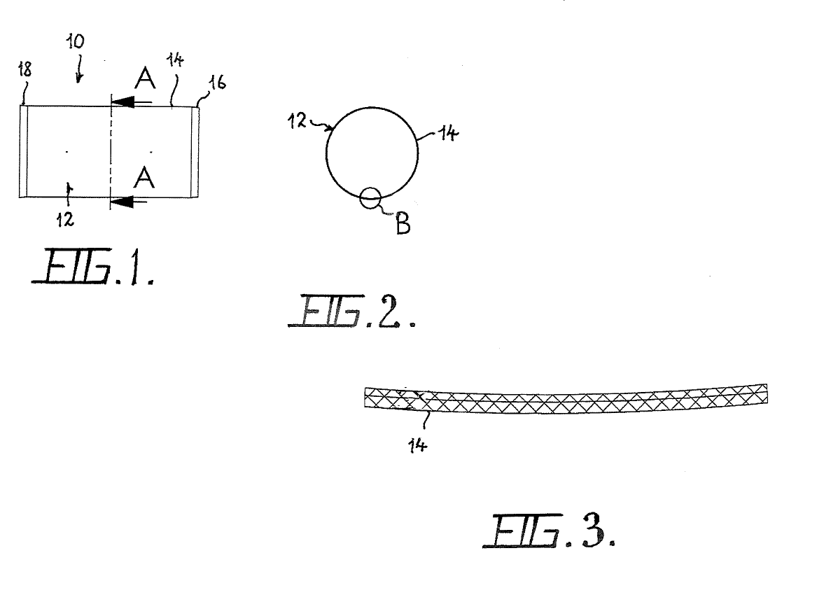

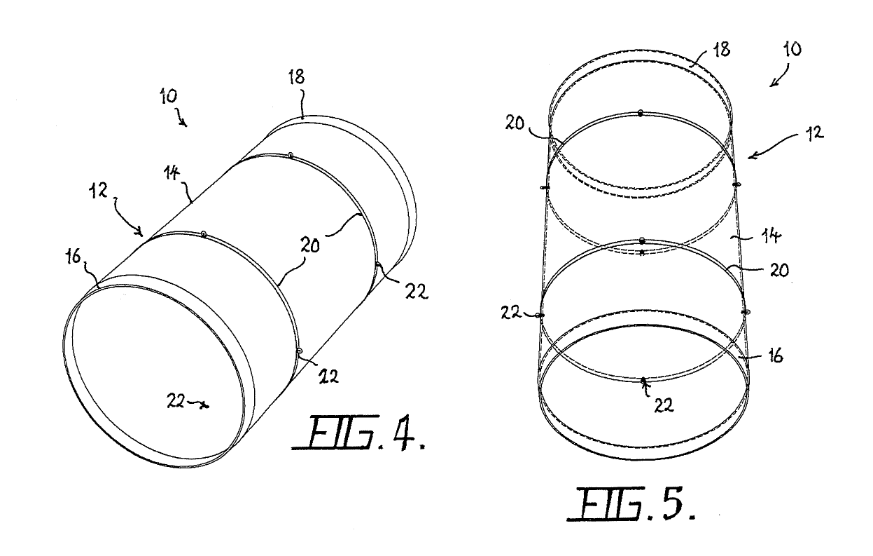

A first embodiment of a ventilation duct 10 in accordance with the invention, as illustrated in FIGS. 1 to 5, comprises a substantially rigid, elongate tube section 12 moulded from plastics material. The tube section 12 has a tube wall 14 comprising a plurality of layers. In this embodiment the tube wall 14 comprises two layers, an inner layer, marked A in FIG. 3, of a first plastics material, and an outer layer, marked B in FIG. 3, of a second plastics material. Preferably at least one of the layers A and B comprises an intumescent material which acts as a fire retardant in the event of exposure to extreme heat. In this embodiment the second plastics material of the outer layer B comprises an intumescent material.

Intumescent materials swell as a result of exposure to heat. Intumescent materials increase in volume and decrease in density to form a char, which is a poor heat conductor and therefore acts as a fire retardant barrier. Intumescent materials are typically applied as a coating or paint.

Rather than being in the form of a coating or paint, the intumescent material employed in the present invention is preferably an intumescent resin, in which the intumescent material is incorporated in a resin matrix. Advantageously the intumescent resin is provided in a powder form suitable for rotational moulding. Typically the intumescent resin is a metallocene polyethylene-based compound. Preferably the intumescent resin is the metallocene polyethylene-based compound called DPO P509 developed by Total Petrochemicals & Refining SA/NV. DPO P509 has a typical density of 1.07 g/cm³, melt flow rate of 12.0 g/10 min, and melting point of 119° C.

Preferably the first plastics material of the inner layer A is a high density polyethylene (HDPE) material.

A method of manufacturing the ventilation duct 10 typically comprises the step of moulding a first layer of plastics material in the form of a tube. This is followed by the step of moulding a second layer of plastics material bonded to the first layer. At least one of the first and second layers comprises an intumescent material. Lastly the plastics material is cured so as to form a substantially rigid tube section having a multi-layer tube wall, and wherein the intumescent material acts as a fire retardant in the event of exposure to extreme heat.

Preferably the tube section 12 is moulded using a rotational moulding process. Typically the moulding process comprises a double-shot rotational moulding process.

Advantageously the tube wall 14 is formed with a bevelled annular edge region 16 at a first end of the tube section 12, and a flared annular edge region 18 at a second end of the tube section 12 wherein, in use, the bevelled annular edge region 16 is adapted to be received in a flared annular edge region 18 of a substantially identical adjacent tube section (not shown), which is joined end to end with the tube section 12. Advantageously, because the bevelled annular edge region 16 is designed to mate with the flared annular edge region 18, there is no discontinuity on the internal surface of the ventilation duct at the join, i.e. the internal dimensions of the duct do not change throughout the length of the duct. This results in improved air flow and minimal turbulence within the ventilation duct.

The bevelled annular edge region 16 of each tube section 12 of a plurality of tube sections may be welded or bonded to the flared annular edge region 18 of each adjacent tube section to form a tube of the required length for the ventilation duct application. It is envisaged that a ventilation duct in the form of a tube made up of a plurality of the tube sections 12 may be up to several kilometres in length. Each tube section 12 is typically 2.4 m in length. Adjoining tube sections may also be clamped at the join if necessary.

In this embodiment each tube section 12 is also provided with a pair of stiffening straps 20, as can be seen most clearly in FIGS. 4 and 5. Stiffening straps 20 are typically made of metal and extend around the circumference of the tube section 12. They are fastened to the tube at spaced intervals with suitable fasteners 22. The straps 20 provide stiffening support for when the tube section 12 is used in a vacuum state. When the tube sections are used in a positive pressure application the straps 20 will not be required.

Another advantage of the tube sections 12 is that they can be readily manufactured with varying wall thicknesses, simply by changing the volume of resin powder used in each shot of the rotational moulding process. This may be particularly advantageous in applications where the tube sections 12 of the ventilation duct closest to a vacuum pump need to be of increased wall thickness to withstand the increased negative pressure.

Typical wall thickness of the double layer tube wall 14 of the first embodiment is about 10 mm. The inner layer, marked A in FIG. 3, of the first plastics material, is typically about 7 mm think, and the outer layer, marked B in FIG. 3, of the second plastics material, is typically about 3 mm thick.

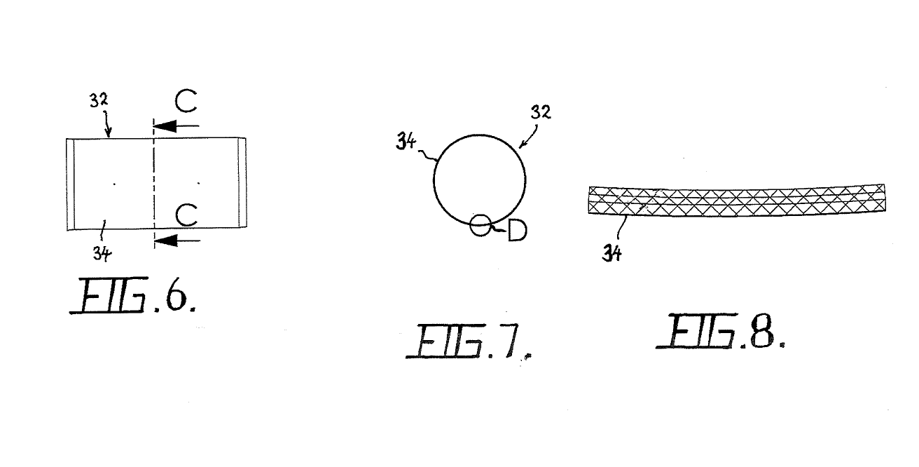

FIGS. 6 to 8 illustrate a second embodiment of the tube section 32 in accordance with the present invention. A tube wall 34 of tube section 32 has an intermediate layer of first plastics material, marked B in FIG. 8, an inner layer of a second plastics material, marked A in FIG. 8, and an outer layer of the second plastics material, marked C. In this embodiment the second plastics material of both the inner layer A and the outer layer C comprises an intumescent material. This configuration may be necessary where it is essential that the ventilation duct have a fire retardant rating on both the internal and external surface of the tube section.

The method of manufacturing the tube section 32 using a rotational moulding process is similar to that described above. The method involves the additional step providing a third shot of the intumescent resin for moulding the third layer of plastics material bonded to the second layer. In other respects the tube section 32 is similar to the first tube section 12 and will not be described again in detail.

Now that preferred embodiments of the ventilation duct have been described in detail, it will be apparent that the described embodiments provide a number of advantages over the prior art, including the following:
(i) By forming the tube section with a multi-layer wall having at least one layer comprising an intumescent material a ventilation duct with the required fire retardant properties can be readily manufactured using known manufacturing techniques;
(ii) The use of an intumescent resin in one of the layers of plastic material used to form the tube section provides a higher fire retardant rating than is currently available using other techniques;
(iii) The wall thickness of the multi-layer wall of the tube section can be readily varied to suit the application.

It will be readily apparent to persons skilled in the relevant arts that various modifications and improvements may be made to the foregoing embodiments, in addition to those already described, without departing from the basic inventive concepts of the present invention. For example, although the ventilation ducts of the illustrated embodiments both comprise tube sections of circular cross-section, it will be appreciated that the tube section of the present invention can be manufactured of any desired cross-sectional shape. Therefore, it will be appreciated that the scope of the invention is not limited to the specific embodiments described.

1. A ventilation duct, the duct comprising:
a substantially rigid, elongate tube section moulded from plastics material and having a tube wall comprising a plurality of layers, at least one of the layers comprising an intumescent material which acts as a fire retardant in the event of exposure to extreme heat.

2. A ventilation duct as defined in claim 1, wherein the tube section has a tube wall comprising an inner layer of a first plastics material and an outer layer of a second plastics material, the second plastics material of the outer layer comprising an intumescent material.

3. A ventilation duct as defined in claim 1, wherein the tube section has an intermediate layer of first plastics material, an inner layer of a second plastics material, and an outer layer of the second plastics material, the second plastics material of both the inner layer and the outer layer comprising an intumescent material.

4. A ventilation duct as defined in claim 2, wherein the second plastics material is a metallocene polyethylene-based compound.

5. A ventilation duct as defined in claim 1, wherein the intumescent material is an intumescent resin provided in a powder form suitable for rotational moulding.

6. A ventilation duct as defined in claim 5, wherein the intumescent resin is a product called DPO P509 developed by Total Petrochemicals & Refining SA/NV.

7. A ventilation duct as defined in claim 6, wherein DPO P509 has a density of 1.07 g/cm³, a melt flow rate of 12.0 g/10 min, and a melting point of 119° C.

8. A ventilation duct as defined in claim 1, wherein the first plastics material is a high density polyethylene (HDPE) material.

9. A ventilation duct as defined in claim 1, wherein the tube section is moulded using a rotational moulding process.

10. A ventilation duct as defined in claim 1, wherein the tube wall is formed with a bevelled annular edge region at a first end of the tube section, and a flared annular edge region at a second end of the tube section wherein, in use, the bevelled annular edge region is adapted to be received in a flared annular edge region of a substantially identical adjacent tube section, which is joined end to end with the tube section.

11. A ventilation duct as defined in claim 10, wherein each tube section is provided with a plurality of stiffening straps at spaced intervals along its length, each strap extending around the circumference of the tube section.

12. A method of manufacturing a ventilation duct, the method comprising the steps of:
moulding a first layer of plastics material;
moulding a second layer of plastics material bonded to the first layer, at least one of the first and second layers including an intumescent material; and,
curing the plastics material so as to form a substantially rigid tube section having a multi-layer tube wall, and wherein the intumescent material acts as a fire retardant in the event of exposure to extreme heat.

13. A method of manufacturing a ventilation duct as defined in claim 12, the method further comprising the step of:
moulding a third layer of plastics material bonded to the second layer.

14. A method of manufacturing a ventilation duct as defined in claim 12, wherein the moulding steps are performed as part of a rotational moulding process.
